(19) United States
(12) Patent Application Publication
(10) Pub. No.: US 2023/0076354 A1
(43) Pub. Date: Mar. 9, 2023

(54) FIBER OPTIC CABLE GRIPPING DEVICE

(71) Applicant: NIPPON TELEGRAPH AND TELEPHONE CORPORATION, Tokyo (JP)

(72) Inventors: Akira SAKURAI, Musashino-shi, Tokyo (JP); Hiroaki TANIOKA, Musashino-shi, Tokyo (JP); Hisashi IZUMITA, Musashino-shi, Tokyo (JP); Yusuke YAMADA, Musashino-shi, Tokyo (JP); Yuta MARUO, Musashino-shi, Tokyo (JP)

(73) Assignee: NIPPON TELEGRAPH AND TELEPHONE CORPORATION, Tokyo (JP)

(21) Appl. No.: 17/798,112

(22) PCT Filed: Feb. 28, 2020
(86) PCT No.: PCT/JP2020/008477

§ 371 Date: Aug. 8, 2022

(51) Int. Cl. G02B 6/44; G02B 6/46

(52) U.S. Cl. CPC G02B 6/4471; G02B 6/46

(57) ABSTRACT

To surely fix an optical fiber cable including a nonmetallic tension member in a closure without damaging the tension member and a core. An optical fiber cable holding device according to the present disclosure includes: a thin plate portion configured, by bending a rectangular thin plate in a length direction thereof into a shape of a rough circle, to hold an outer periphery of an optical fiber cable; a binding mechanism portion fixed on one end of the thin plate portion and configured to bind and fix the thin plate portion wound around the optical fiber cable; protrusion fitting holes provided on the other end of the thin plate portion wound around the optical fiber cable; and a band-diameter adjuster fixed to the binding mechanism portion, including a protrusion to fittable into each of the protrusion fitting holes, and configured to adjust a diameter of the rough circle by changing from one hole to another hole of the protrusion fitting holes to be fitted onto the protrusion.

### TECHNICAL FIELD

The present disclosure relates to an optical fiber cable holding device for holding an optical fiber cable.

### BACKGROUND ART

In an optical fiber cable used for communication, a tension member such as steel wire is disposed to prevent an optical fiber core from being stretched more than necessary, for the purpose of securing quality of the communication. In an optical cable connection closure that is used for connection and the like of the optical cable, the optical fiber cable is fixed to prevent bending and damage of optical fibers caused by movement of the optical fiber cable.

For example, Patent Literature 1 discloses that steel wire is suitable for the tension member. Further, Patent Literature 2 discloses a mechanism for bending and press-contact of the tension member and a member for holding an end of a cable.

To lay the optical fiber cable in a section where suppression of electromagnetic induction is required, it is necessary to use a cable including a nonmetallic tension member. An example of the nonmetallic tension member is made of, for example, glass fiber or chemical fiber as a main material. The optical fiber cable is typically required to be housed and fixed in the closure for connection and the like.

Typically, the optical fiber cable is fixed at two positions in the closure. At one of the two positions, the optical fiber cable is held by bending and pressure-contact of the tension member as disclosed in Patent Literature 2. At the other position, the optical fiber cable is held in such a manner that a cable jacket is sandwiched. When the former method is applied to the nonmetallic tension member, the tension member may be damaged because the material of the tension member is fragile unlike a metal, and a holding method to fix the tension member itself is cannot be used. Therefore, the cable is required to be fixed only by the latter method; however, it is not possible to hold the cable with strength sufficient to fix the cable at the single position because large sandwiching force causes buckling deformation of the cable jacket and damages the optical fiber core.

### CITATION LIST

### Patent Literature

Patent Literature 1: Japanese Patent Publication No. 7-111493
Patent Literature 2: Japanese Patent No. 4209836

### SUMMARY OF THE INVENTION

### Technical Problem

The present disclosure is to solve the above-described issues, and an object of the present disclosure is to fix an optical fiber cable having a nonmetallic tension member in a closure without damaging the tension member and a core.

### Means for Solving the Problem

The invention to solve the above-described issues is a method to fix an optical fiber cable having a nonmetallic tension member in a closure by using a holding band, and the holding band causes appropriate gripping force and appropriate frictional force to act on the cable, which enables fixing of the cable by holding at a single point and eliminates damage by press-contact of the nonmetallic tension member.

More specifically, an optical fiber cable holding device according to the present disclosure includes: a thin plate portion configured, by bending a rectangular thin plate in a length direction thereof into a shape of a rough circle, to hold an outer periphery of an optical fiber cable; a binding mechanism portion fixed on one end of the thin plate portion and configured to bind and fix the thin plate portion wound around the optical fiber cable; protrusion fitting holes provided on the other end of the thin plate portion wound around the optical fiber cable; and a band-diameter adjuster fixed to the binding mechanism portion, including a protrusion fittable into each of the protrusion fitting holes, and configured to adjust a diameter of the rough circle by changing from one hole to another hole of the protrusion fitting holes to be fitted onto the protrusion.

### Effects of the Invention

According to the present disclosure, it is possible to fix the optical fiber cable having the nonmetallic tension member in the closure without damaging the tension member and the core.

### BRIEF DESCRIPTION OF DRAWINGS

FIG. 1 is a perspective view illustrating an example of a holding band according to the present disclosure.

FIG. 2 is a cross-sectional view illustrating an example of an optical fiber cable.

FIG. 3 illustrates a configuration in which the optical fiber cable is held by the holding band in a closure.

FIG. 4 illustrates an example of a holding configuration according to a first embodiment as viewed from a cable longitudinal direction.

FIG. 5 illustrates examples of parameters of the optical fiber cable.

FIG. 6 illustrates an example of a holding configuration according to a second embodiment as viewed from the cable longitudinal direction.

FIG. 7 illustrates an example of a thin plate elastic body.

FIG. 8 illustrates an example of the thin plate elastic body when predetermined pressure is applied to the optical fiber cable.

FIG. 9 illustrates an example of a holding configuration according to a third embodiment.

FIG. 10 is an example of an enlarged view of a frictional force application portion.

### DESCRIPTION OF EMBODIMENTS

Some embodiments of the present disclosure are described in detail below with reference to drawings. Note that the present disclosure is not limited to the embodiments described below. These embodiments are merely examples, and the present disclosure can be implemented in forms obtained by variously alternating or modifying the embodiments based on the knowledge of those skilled in the art. Note that, in the present specification and the drawings, components denoted by the same reference numerals mutually denote the same components.

### First Embodiment

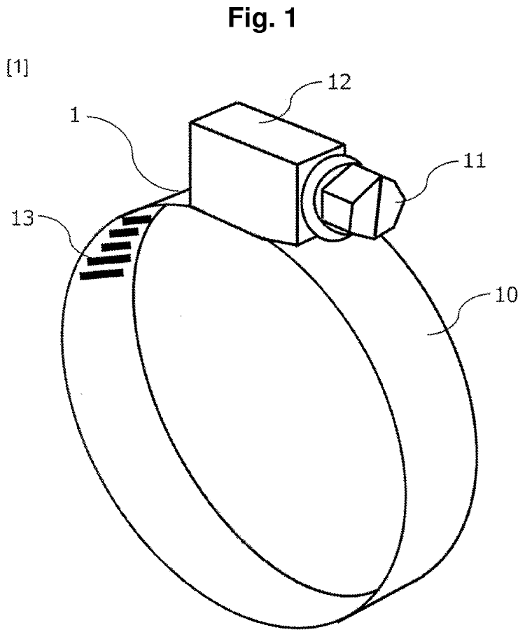

FIG. 1 is a perspective view of a holding band according to the present disclosure. A holding band 1 according to the present disclosure functions as an optical fiber cable holding device, and includes a thin plate portion 10, a band-diameter adjuster 11, a binding mechanism portion 12, and protrusion fitting holes 13.

The holding band 1 is manufactured by processing a metal such as stainless steel or a nonmetallic synthetic resin. The band-diameter adjuster 11 and the binding mechanism portion 12 housing the band-diameter adjuster 11 are connected and fixed to one end of the thin plate portion 10. The protrusion fitting holes 13 to be screwed onto protrusions of the band-diameter adjuster 11 are provided on the other end of the thin plate portion 10. The thin plate portion 10 can pass through the binding mechanism portion 12 by being wound, and the band-diameter adjuster 11 fitted to the protrusion fitting holes 13 is tightened to adjust a diameter of a rough circle formed by the thin plate portion 10 and to have a firm grip on an optical fiber cable 2.

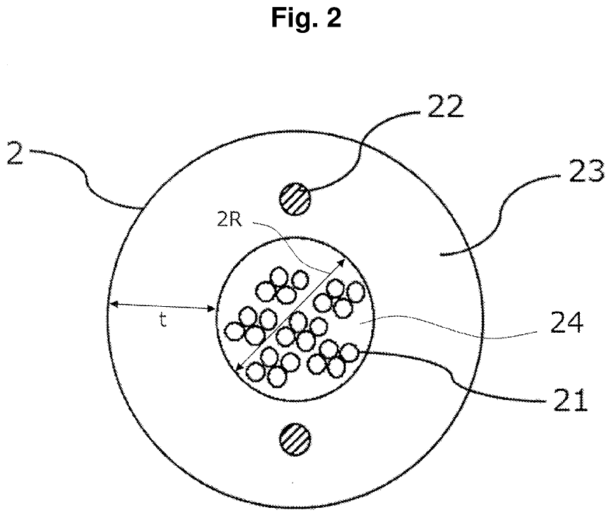

FIG. 2 is a cross-sectional view of the optical fiber cable 2. The optical fiber cable 2 may have a self-supporting structure used for a case where the optical fiber cable 2 is laid between utility poles or is laid from a utility pole to a subscriber home. In this case, a supporting line is separated and the optical fiber cable 2 includes only a main body portion. The optical fiber cable 2 includes optical fibers 21, tension members 22 and a jacket 23 that is made of thermoplastic resin. Note that the configuration of the optical fiber cable 2 is not limited hereto as long as the optical fibers 21 are disposed inside an inner cavity 24. The optical fibers 21 transmit optical signals used for communication. The tension members 22 have a function to prevent the optical fibers 21 from being damaged by application of excessive tension on the optical fibers 21 in a longitudinal direction. The tension members 22 are each made of nonmetallic material such as glass fiber reinforced plastic, and does not cause electromagnetic induction.

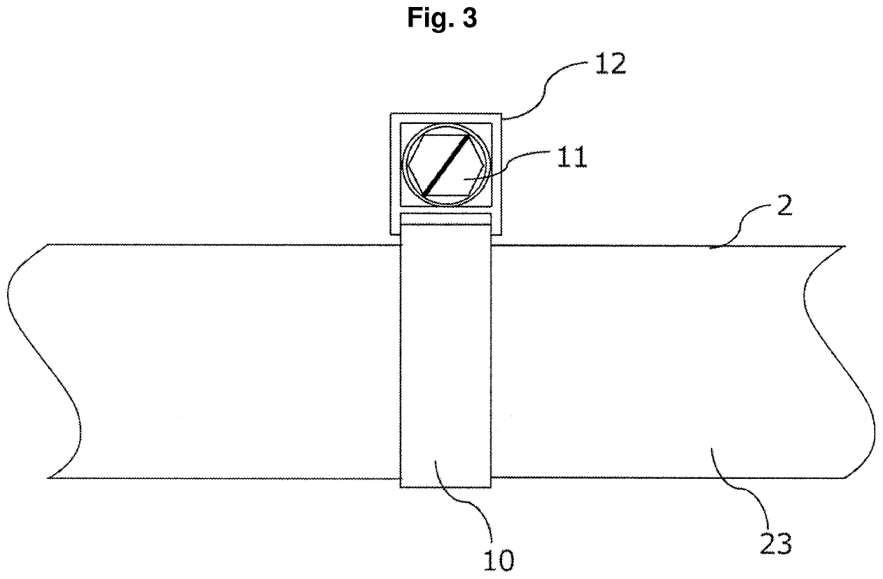

FIG. 3 illustrates a configuration in which the optical fiber cable 2 is held by the holding band 1 in a closure. The holding band 1 is attached and wound around the optical fiber cable 2. The binding mechanism portion 12 has a shape engageable with a screwing tool such as a driver and a wrench, and can apply appropriate tightening pressure to the optical fiber cable 2. The optical fiber cable 2 is fixed only by the holding band 1. The tension members 22 themselves are not directly and mechanically press-fixed in the closure. Therefore, even when the tension members 22 are each made of a nonmetallic material, the tension members 22 are not damaged. In addition, fixing only by the holding band 1 makes it possible to improve work efficiency. Note that a member to be fixed to the closure may be attached to the holding band 1.

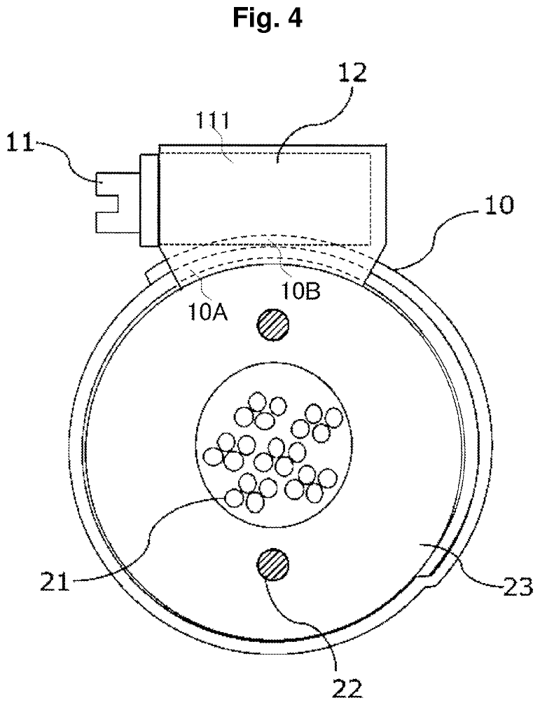

FIG. 4 illustrates the holding configuration as viewed from the cable longitudinal direction, and illustrates a mechanism applying pressure to the optical fiber cable 2. One end 10A of the thin plate portion 10 is fixed to the binding mechanism portion 12. The other end 10B of the thin plate portion 10 is provided with the protrusion fitting holes 13, and the protrusion fitting holes 13 fit onto protrusions of a convex portion 111 of the band-diameter adjuster 11. The holding band 1 can have a firm grip on the optical fiber cable 2 such that the thin plate portion 10 comes into close contact with the optical fiber cable 2, and can uniformly apply the pressure in a circumferential direction. The holding band 1 can prevent buckling deformation of the optical fiber cable 2 and the jacket 23 in a case where the pressure is applied to the optical fiber cable 2 and the jacket 23 in one direction.

Deformation of the jacket 23 occurred by applying the pressure to the optical fiber cable 2 causes contraction of an area of the inner cavity of the optical fiber cable 2. The plurality of optical fibers 21 stored in the optical fiber cable 2 closely contact with one another to generate excessive bending, which influences communication. In a condition where pressure p in a radial direction is applied to the circular optical fiber cable 2 along the circumference, a reduction amount ΔR of a radius R of the inner cavity of the optical fiber cable 2 can be determined by an expression (1) with use of a Young's module E of the jacket 23.

(Math. 1)

ΔR=pR²/tE (1)

In a condition where the optical fiber cable 2 is gripped by the holding band 1, a cross-sectional area S that is a limit for influence on the communication is determined by an expression (2).

(Math. 2)

S=p(R−ΔR)² (2)

Therefore, the pressure p to fix the optical fiber cable 2 can be increased to a value determined by an expression (3).

$$( Math . 3 )$$

$$p = \frac{tE ( R - \sqrt{S / π} )}{{R}^{2}} \qquad ( 3 )$$

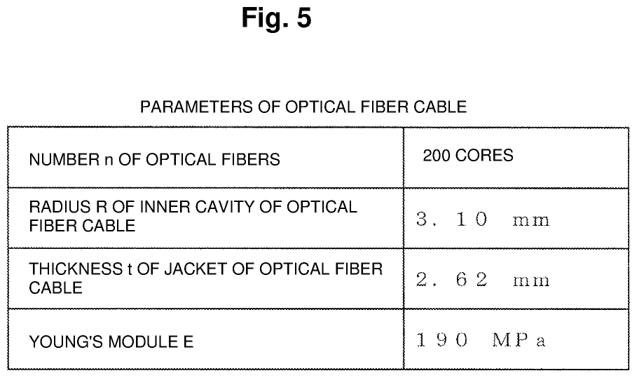

As an example, a test in which crushing pressure is applied so as to sandwich two points of a commercially-available optical fiber cable having specifications of FIG. 5 was performed. As a result, loss occurred on the optical fiber when the cross-sectional area S reached 15.3 cm². Therefore, the holding band 1 satisfies an expression of the pressure p≤46 MPa to fix the optical fiber cable, as gripping force.

When the optical fiber cable 2 is stretched in such a manner that one end of the optical fiber cable 2 is held in the closure and the other end is anchored to a utility pole or the like, tension in the longitudinal direction occurs on the optical fiber cable 2 due to action of a weight of the cable itself, a wind pressure load applied to the cable, and the like. Hereat, to fix the optical fiber cable 2 in the closure, it is necessary to satisfy an expression (4),

(Math. 4)

F≤2πμw(R+t)p, (4)

where w is a width of the thin plate portion 10 of the holding band 1, μ is a static friction coefficient between the thin plate portion 10 and the optical fiber cable 2, and F is the tension applied to the optical fiber cable in the longitudinal direction of the optical fiber cable. Therefore, the holding band 1 satisfies the gripping force expressed by an expression (5).

(Math. 5)

F/2πμw(R+t)≤p (5)

### Second Embodiment

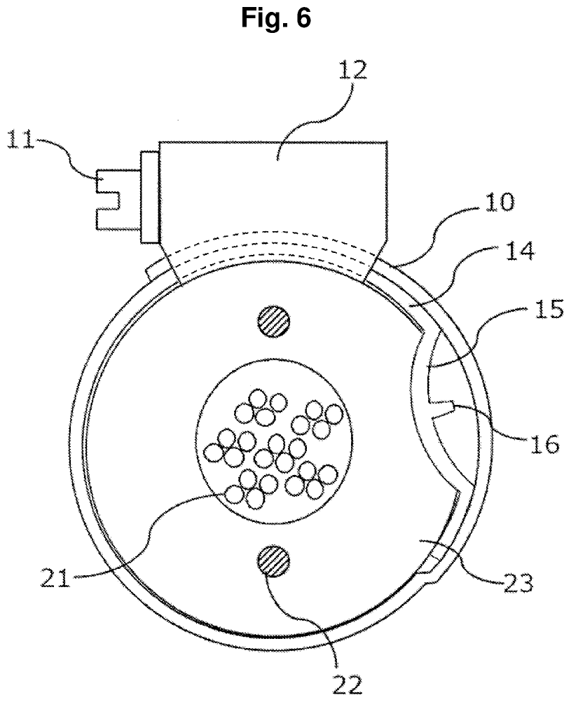

FIG. 6 illustrates an example of a holding configuration according to the present embodiment. The holding band 1 according to the present embodiment further includes a thin plate elastic body 14, an elastic curved portion 15, and a protrusion 16.

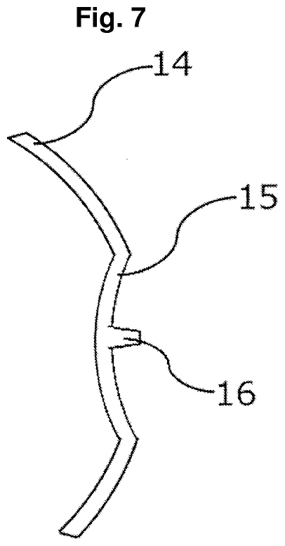

The gripping force expressed by the above-described expression (5) is realized by the thin plate elastic body 14 illustrated in FIG. 7. The thin plate elastic body 14 includes the elastic curved portion 15 that is curved in an elliptical shape so as to externally contact with the jacket 23 of the optical fiber cable. When the pressure occurring on an external contact point between the elastic curved portion 15 and the optical fiber cable 2 is increased by tightening the band-diameter adjuster 11, a curvature of the elastic curved portion 15 is reduced.

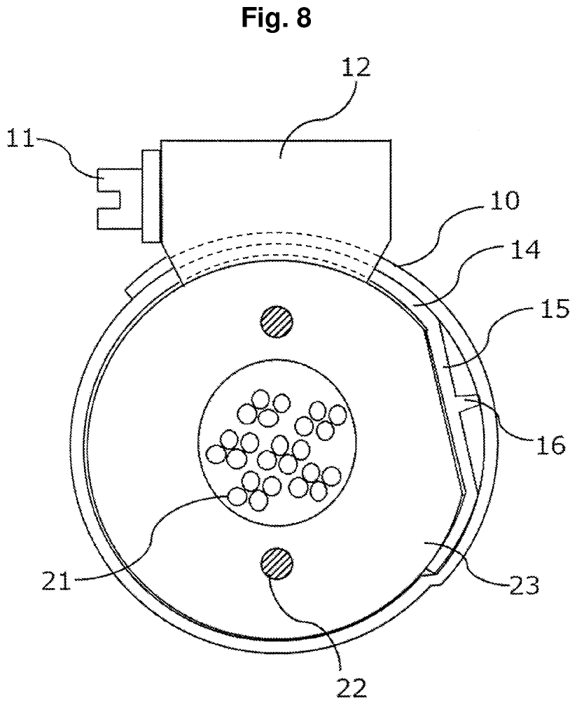

The elastic curved portion 15 includes the protrusion 16 on a rear surface of the external contact point with the optical fiber cable 2. When the pressure is applied to the optical fiber cable 2 and the above-described curvature is reduced, the protrusion 16 is caused to fit into one of the protrusion fitting holes 13 as illustrated in FIG. 8, and the band-diameter adjuster 11 is not rotated any more.

### Third Embodiment

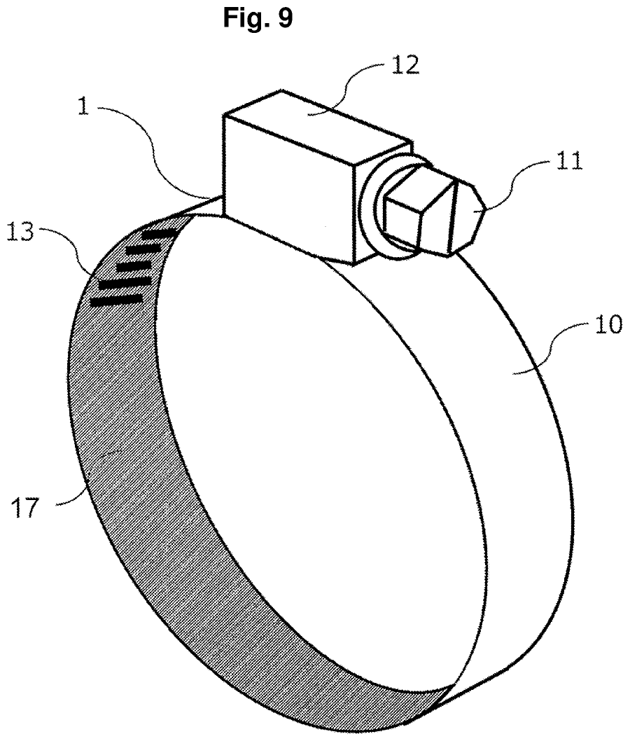

In a configuration according to an embodiment illustrated in FIG. 9, a frictional force application portion 17 is added to a surface of the thin plate portion 10. The frictional force application portion 17 increases frictional force on a surface of the holding band 1 contacting with the optical fiber cable 2, which makes it possible to fix the optical fiber cable 2 in the closure when the tension in the cable longitudinal direction occurs on the optical fiber cable 2. The frictional force application portion 17 is realized by, for example, application of a friction material or formation of roughnesses on the thin plate portion. The configuration according to the present embodiment is applicable to the first embodiment and the second embodiment.

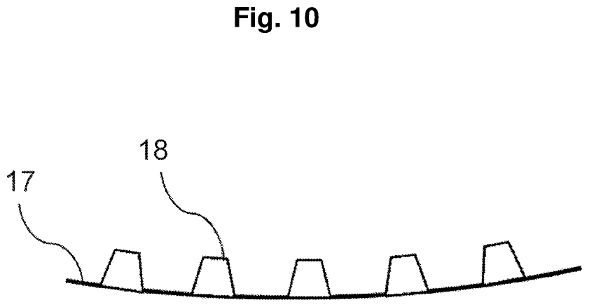

FIG. 10 illustrates an example of holding protrusions 18 formed by the friction material added to the frictional force application portion 17 or the roughnesses provided on the thin plate portion 10. A shape of each of the holding protrusions 18 does not damage the jacket 23, and does not influence on the optical fibers 21 inside the optical fiber cable 2 and on communication. Further, the shape of each of the holding protrusions 18 may have a height smaller than a thickness of the jacket of the optical fiber cable 2, and may be a symmetric protrusion or may be an asymmetric shape to bite into the jacket 23, which is deformed due to the tension applied in the longitudinal direction.

The above-described frictional force application portion and the above-described holding protrusions are added to increase the static frictional coefficient μ acting between the jacket of the optical fiber cable and the holding portion, thereby sufficiently satisfying the following expression. This makes it possible to surely fix the optical fiber cable without applying pressure causing loss of the optical fibers.

$$( Math . 6 )$$

$$μ \geq \frac{{R}^{2} F}{2 π wtE ( R + t ) ( R - \sqrt{S / π} )} \qquad ( 6 )$$

The above-described embodiments do not limit the present invention, may be alternated and modified without departing from the gist of the present invention, and includes equivalents thereof.

### INDUSTRIAL APPLICABILITY

The present disclosure is applicable to information and communication industry.

### REFERENCE SIGNS LIST

1 Holding band
10 Thin plate portion
11 Band-diameter adjuster
12 Binding mechanism portion
13 Protrusion fitting hole
14 Thin plate elastic body
15 Elastic curved portion
16, 111 Protrusion
17 Frictional force application portion
18 Holding protrusion
2 Optical fiber cable
21 Optical fiber
22 Tension member
23 Jacket
24 Inner cavity

1. An optical fiber cable holding device, comprising:
a thin plate portion configured, by bending a rectangular thin plate in a length direction thereof into a shape of a rough circle, to hold an outer periphery of an optical fiber cable;
a binding mechanism portion fixed on one end of the thin plate portion and configured to bind the thin plate portion wound around the optical fiber cable on the one end of the thin plate portion;
protrusion fitting holes provided on the other end of the thin plate portion wound around the optical fiber cable; and
a band-diameter adjuster fixed to the binding mechanism portion, including a protrusion fittable into each of the protrusion fitting holes, and configured to adjust a diameter of the rough circle by changing from one hole to another hole of the protrusion fitting holes to be fitted onto the protrusion.

2. The optical fiber cable holding device according to claim 1, wherein the band-diameter adjuster includes a mechanism to limit pressure, applied from the thin plate portion to the optical fiber cable, to a predetermined value or less.

3. The optical fiber cable holding device according to claim 2, wherein the predetermined value satisfies a following expression,
$$[ Math . C 1 ]$$
$$\frac{F}{2 π μ w ( R + t )} ≦ p ≦ \frac{tE \{ R - \sqrt{\frac{S}{π}} \}}{{R}^{2}} \qquad ( C 1 )$$
where p is pressure applied to the optical fiber cable, R is a radius of an inner cavity of the optical fiber cable, t is a thickness of a jacket of the optical fiber cable, E is a Young's module of the jacket, S is a cross-sectional area of the inner cavity, w is a width of the thin plate portion, μ is a static friction coefficient acting between the jacket of the optical fiber cable and the thin plate portion, and F is tension applied to the optical fiber cable in a longitudinal direction of the optical fiber cable.

4. The optical fiber cable holding device according to claim 2, wherein
the band-diameter adjuster includes a thin plate elastic body curved to protrude toward the optical fiber cable,
the protrusion of the band-diameter adjuster is provided on a surface, not contacting with the optical fiber cable, of the thin plate elastic body, and
by predetermined pressure occurring between the thin plate elastic body and the optical fiber cable, a curvature of the thin plate elastic body is reduced, the protrusion is caused to fit into one of the protrusion fitting holes of the thin plate portion, and the diameter of the rough circle is fixed.

5. The optical fiber cable holding device according to claim 1, wherein a friction material having a static frictional coefficient higher than a static friction coefficient of the thin plate portion is provided on a surface, contacting with the optical fiber cable, of the thin plate portion.

6. The optical fiber cable holding device according to claim 1, wherein
the thin plate portion includes a holding protrusion that fixes the optical fiber cable when tension is applied to the optical fiber cable in a longitudinal direction of the optical fiber cable, and
a height of the holding protrusion is smaller than a thickness of a jacket of the optical fiber cable.
